(19) United States
(12) Patent Application Publication
(10) Pub. No.: US 2023/0040193 A1
(43) Pub. Date: Feb. 9, 2023

(54) MULTI-COPY JOBS WITH NETWORK STORAGE

(71) Applicant: HEWLETT-PACKARD DEVELOPMENT COMPANY, L.P., Spring, TX (US)

(72) Inventors: Brian Christopher MAYER, Boise, ID (US); Dean Jonathan RICHTSMEIER, Singapore (SG)

(21) Appl. No.: 17/394,987

(22) Filed: Aug. 5, 2021

(51) Int. Cl. G06F 3/12

(52) U.S. Cl. CPC G06F 3/1267; G06F 3/1215; G06F 3/1285

(57) ABSTRACT

An example non-transitory machine-readable medium includes instructions that, when executed by a processor, cause the processor to receive a job to print multiple copies of a document, process a page of the document to obtain a processed page, initiate printing of the processed page at a printer, transmit via a network the processed page to network storage, and, when ready to print a subsequent copy of the page of the document, retrieve via the network the processed page from the network storage.

### BACKGROUND

Printing is used to render electronic documents on physical media, such as paper, plastic, cardstock, and the like. A printing device may transfer a document to physical media using an electro-mechanical marking device (e.g., an inkjet printhead, laser and toner device, etc.) that cooperates with a media conveyance mechanism (e.g., trays, rollers, etc.) that transports the medium to and from the marking device. Printing devices may be capable of printing multiple copies of a document in a desired sequence, such as collated copies of the document. Printing devices may also be capable of copying documents.

### BRIEF DESCRIPTION OF THE DRAWINGS

FIG. 1 is a block diagram of an example non-transitory machine-readable medium with instructions to store and retrieve processed pages via network storage during the printing of multiple copies of a document.

FIG. 2 is a schematic diagram of example communications between a printing device and network storage to store and retrieve processed pages in accordance with a network delay.

FIG. 3 is a schematic diagram of example communications between a printing device and network storage to compute and update a network delay.

FIG. 4 is a schematic diagram of example communications between a printing device and network storage to compute a network delay using test data and update the network delay using processed page data.

FIG. 5A is a schematic diagram of example instructions, page buffer, and network storage to process pages and store processed pages in a coordinated manner.

FIG. 5B is a schematic diagram of the example instructions, page buffer, and network storage of FIG. 5A at a later state.

FIG. 6 is a block diagram of an example printing device that uses a remote network storage location to temporarily store processed pages during a multi-copy print job.

FIG. 7 is a flowchart of an example method of storing and retrieving processed pages via network storage during the printing of multiple copies of a document.

### DETAILED DESCRIPTION

Printing or copying multiple copies of a document may be complicated and inefficient.

Some printers rely on a host (e.g., a user computer) that initiated a print job to manage the printing of multiple copies. The host may determine when a page is to be sent to the printer. This increases processing complexity at the host and, depending on page complexity, may reduce the throughput of the printer, as the printer may be waiting for pages from the host.

Another approach is to install sufficient volatile memory at the printer to store all pages of a document, so that when a page is to be printed as part of a second or subsequent copy, the page is available in memory. This adds to the cost and complexity of the printer. Moreover, this approach does not work for documents of arbitrary size. That is, at some point, the printer may be provided with a document of a size that does not fit in the printer's memory. Non-volatile memory (e.g., flash memory, hard drive, etc.) may be provided to the printer to reduce the demand for volatile memory, but this requires an additional component to be added to the printer and the relatively slow speed of non-volatile memory may reduce the throughput of the printer.

In copiers and multi-function devices (e.g., a printer that has copying and perhaps scanning functionality), volatile memory may also be limited. In some cases, a copy function is limited to a single copy if a document exceeds memory capacity. For example, if a user selects multiple copies when providing a document to an automatic document feeder, the copier may determine during the copy job that the document exceeds its memory capacity and may, in response, override the user's selection of multiple copies and merely make a single copy because the document cannot be stored in memory for recall to make subsequent copies.

According to the techniques discussed herein, network storage may be used store processed (e.g., rendered and compressed) pages during a multi-copy print job. When a first copy of a page is to be printed, the page is processed, printed, and then stored at a network storage location in processed form. When a second or subsequent copy of the page is to be printed, the processed page is retrieved from the network storage location. This avoids storing processed pages at the printer, which may not be possible in memory-limited printers, and avoids relying on a host to manage multiple copies.

A latency or delay of the network storage location may be characterized, and the retrieval of a processed page and be coordinated, so that the processed page arrives at the printer when needed. A buffer at the printer can be kept at a desired operating level provide page data to the conveyance and marking mechanism when ready, so as to reduce the likelihood of the mechanism cycling in and out of continuous operation and to promote high page throughput.

For purposes of this description, copying a document is analogous to printing the document, with a difference often being the source of the document. A host, such as a computing device, may provide an electronic document to print. When copying a document that exists on a physical medium, an automatic document feeder and scanner are often used.

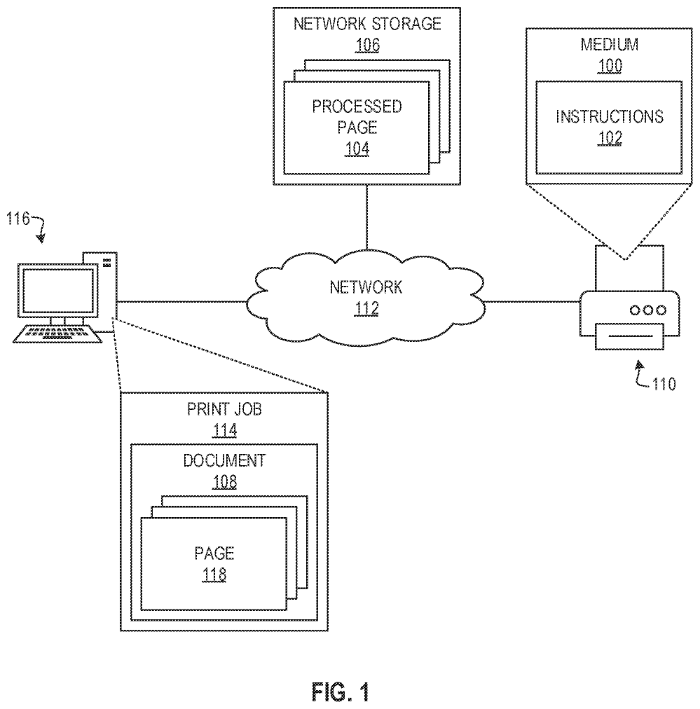

FIG. 1 shows an example non-transitory machine-readable medium 100 with instructions 102 to store and retrieve processed pages 104 via network storage 106 during the printing of multiple copies of a document 108.

The non-transitory machine-readable medium 100 may include a non-volatile memory, such as read-only memory (ROM), electrically-erasable programmable read-only memory (EEPROM), or flash memory that cooperates with a processor to execute the instructions. The non-transitory machine-readable medium 100 may include an electronic, magnetic, optical, or other physical storage device that encodes the instructions 102 that implement the functionality discussed herein.

The instructions 102 are executable by a processor. The instructions 102 may be directly executed, such as binary or machine code, and/or may include interpretable code, bytecode, source code, or similar instructions that may undergo additional processing to be executed. All of such examples may be considered executable instructions.

The instructions 102 may form part of the firmware of a printing device 110, such as an inkjet printer, laser printer, or multi-function device, that is connected to a computer network 112, such as a local-area network (LAN), a wide-area network (WAN), a wireless network, the internet, or a combination of such.

The instructions 102 receive a print job 114 from a host 116, which may be a print service, a server, or a user computing device, such as a desktop computer, notebook computer, all-in-one (AiO) computer, tablet computer, smartphone, or similar device. The print job 114 may be received via a direct wired or wireless connection (e.g., Wi-Fi™, Bluetooth™, or Universal Serial Bus™) or via the network 112. The print job 114 indicates the document 108 to print as well as a number of requested copies of the document 108. The print job 114 may be expressed in a Printer Job Language (PJL). The below discussion concerns a request to print multiple collated copies of the document 108.

In other examples, the instructions 102 receive a print job 114, which may be termed a copy job, from a copier function that may control an automatic document feeder and scanner.

The instructions 102 process a page 118 of the document 108 to obtain a processed page 104. Processing may include rendering data of the page 118. Rendering may include rasterizing text and vector data that is to be printed, where such data may be expressed in a Page Description Language (PDL) and/or a Printer Control/Command Language (PCL). Processing may further include compressing the data after it is rendered. The processed page 104 may be termed a rendered and compressed page.

The instructions 102 initiate printing of the processed page 104 at the printer 110. This may include queuing the processed page 104 at a buffer or other area of memory. The processed page 104 may subsequently be dequeued from the buffer at an appropriate time to provide the processed page 104 to a print engine of the printer 110, so that the processed page 104 may be printed to a physical print medium, such as paper.

During the printing of the first copy of the document 108, the instructions 102 may transmit the processed page 104, via the network 112, to the network storage 106. Given that multiple copies of the document 108 may be requested by the host 116, storing the processed page 104 at the network storage 106 avoids having to store the processed page 104 in memory of the printer 110 until the next copy of the document 108 is to be printed and avoids having to re-process the page 118 if the processed page 104 for the current copy is simply discarded. The instructions 102 may transmit each processed page 104 to the network storage 106 in sequence, as the instructions 102 process each page 118 of the document 108. Hence, during the course of processing and printing the first copy of the document 108, the network storage 106 receives a complete set of processed pages 104 for later use.

The instructions 102 determine when the printer 110 is ready to print the next copy of the page 118 of the document 108 and accordingly retrieves, via the network 112, the respective processed page 104 from the network storage 106. The processed page 104 may then be queued for printing at a buffer, as discussed above.

The network storage 106 may be remote from the printing device 110 and remote from the host 116 that requested the print job 114. The network storage 106 may be located at a server. Alternatively, the network storage 106 may be located at the host 116. The network storage 106 may be implemented as a network directory, file share, datastore, database, block-level storage, or similar repository.

The network storage 106 may include file-level storage, such as Network-Attached Storage (NAS). The network storage 106 may include block-level storage, such as a Storage Area Network (SAN). A combination of NAS and SAN may be used.

Storage of processed pages 104 at the network storage 106 may be temporary and may be limited to the longest expected time for the print job 114 to complete. As such, the network storage 106 may be regularly cleared, such as hourly or daily. Processed pages 104 may be timestamped or otherwise associated with a time of the print job 114. The network storage 106 may be configured to regularly purge processed pages 104 accordingly. Alternatively, the instructions 102 may indicate to the network storage 106 when the print job 114 is completed and thus when any processed pages 104 of the print job 114 may be deleted from the network storage 106.

The instructions 102 may be configured with access information for the network storage 106, such as a network address and login credentials. Access information may be user configurable or pre-programmed at time of manufacture or installation. The instructions 102 may implement a server, such as a web server to communicate with the network storage 106.

When connecting to the network storage 106, the instructions 102 may reserve an amount of network storage 106 based on the number of the pages 118 of the document 108. The instructions 102 may initially parse the document 108 to determine the number of pages or may refer to metadata indicating the number of pages, if provided, with the print job 114.

The host 116 may include an indication of a number of pages in the print job 114. For example, the host 116 may insert a code such as “@PJL PAGES=5” or “@PJL TOTALPAGES=5” to indicate that the document 108 contains five pages. Such code may be embedded in PDL. The instructions 102 may read this code and reference the number of pages 118 to manage usage of the print buffer. For example, in some cases, foreknowledge of the number of pages 118 of the document 108 may allow the instructions 102 to request processed pages 104 from the network storage 106 earlier than would be possible when determining the number of pages 118 during the processing of the document 108. That is, the instructions 102 may determine that the number of pages 118 will not use the full capacity of the print buffer. The surplus capacity of the print buffer can thus be used to queue processed pages 104, as obtained from network storage 106, for a subsequent copy.

The instructions 102 may further determine a network delay or latency associated with the network storage, and coordinate retrieval of processed pages 104 from the network storage 106 based on the network delay. The instructions 102 may request a processed page 104 from the network storage 106 at a time that promotes the sustained and continuous printing of the multiple copies of the document 108. For example, the instructions 102 may coordinate requests for processed pages 104 to maintain a buffer at the printer with a number of processed pages 104 that is suitable for sustained printing of the multiple copies of the document 108. If the buffer empties before the completion of a print job 114, then the printer 110 may transition from an active printing state to an idle state. Entering the idle state may cause maintenance to occur (e.g., automatic cleaning of inkjet nozzles) and may cause mechanical components of the printer 110 to be stowed at rest positions. Cycling between active and idle states may cause mechanical components to wear over time. Hence, the buffer may be kept at a level that is conducive for continuous printing of multiple copies and that reduces the risk that the printer 110 will unnecessarily enter the idle state before the print job is completed, which over time could lead to premature wear of printer components. Irrespective of an idle state and printer wear, keeping the buffer at a level suitable for sustained printing may reduce the total time to complete the print job, in that a print engine may not be left waiting for the next page. In various example, the instructions 102 may coordinate the retrieval of processed pages 104 from the network storage 106 to maintain the buffer as full as possible.

The buffer may be a designated area of a volatile memory at the printing device 110. Hence, a certain amount of space of the volatile memory may be reserved for processing pages 118 of the document 108. The amount of memory used as working memory and as a buffer for processed pages may be variable and may change during the printing of the document. Working memory and other memory that is not useable as buffer may be considered when determining when to request retrieval of a processed page 104 from the network storage 106.

The instructions 102 may determine and store (e.g., at the medium 100) metadata of processed pages 104 as shown in Table 1.

TABLE 1

| | | Measured |
|---|---|---|
| | | Network |
| Page | Size | Delay |
| No. | (megabytes) | (milliseconds) |
| 1 | 3 | 505 |
| 2 | 2.5 | 451 |
| 3 | 3.2 | 632 |
| 4 | 0.6 | 208 |
| 5 | 3.1 | 395 |

Page number or other identifier allows the identification of the processed page in a request. Size may allow the instructions 102 to determine whether the page buffer has sufficient space for the processed page. Measured network delay may allow the instructions 102 to fine-tune the timing of a request for the particular page.

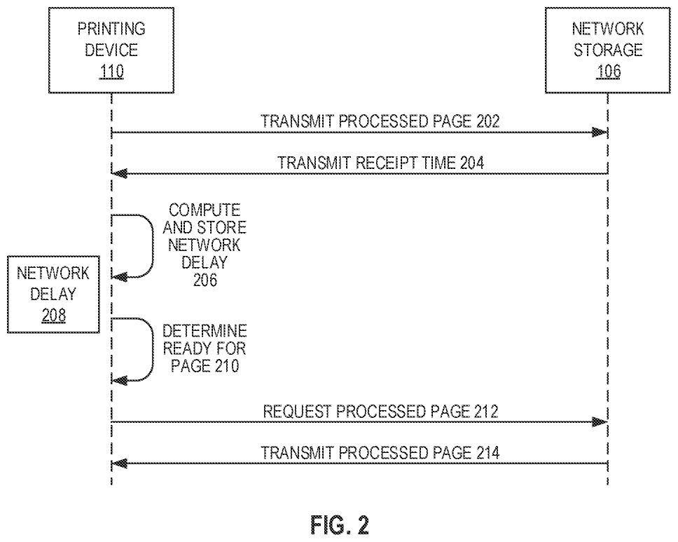

With regard to coordinating retrieval of processed pages from network storage based on network delay or latency, FIG. 2 shows example communications between a printing device 110 and remote network storage 106 to store and retrieve processed pages in accordance with a measured network delay.

The printing device 110 may include a buffer and instructions, such as instructions 102 (FIG. 1), that initiate printing and perform the functionality discussed herein. The network storage 106 may be in communication with the printing device 110 via a computer network 112.

After processing a page of a document of a print job, the printing device 110 may transmit 202 the processed page to the network storage 106 for temporary storage until the processed page is to be printed again, such as during the printing of a subsequent copy of the document. The printing device 110 may include a clock and may record the time that the transmitting 202 of the processed page was initiated. Time may be treated as Unix epoch time or with some other format and may have millisecond resolution.

The network storage 106 may include a clock that is synchronized with the clock of the printing device 110. The network storage 106 may record a time of receipt of the processed page and may transmit 204 an indication of the time of receipt to the printing device 110.

The printing device 110 may compute and store 206 the network delay 208 as the difference between the time of transmission (as stored) and time of receipt (as received from the network storage 106). The network delay 208 may represent the time that it takes to communicate the processed page between the printing device 110 and network storage 106. The network delay 208 may be considered valid for either direction of transmission even if only measured for one direction.

Subsequently, the printing device 110 may coordinate retrieval of the processed page from the network storage 106 based on the network delay 208. the printing device 110 may determine 210 that it is ready to obtain the processed page from network storage 106. The printing device 110 may make this determination based on its page buffer status, such as whether the page buffer has or will soon have sufficient free space for another processed page, and the network delay 208. For example, the printing device 110 may monitor a buffer status to determine that the buffer has space ready to receive a processed page from the network storage 106, and the printing device 110 may reference the network delay 208 to obtain the processed page from the network storage 106 before the buffer empties. The determination 210 with regard to the network delay 208 may be made to prevent the buffer from emptying and to keep the buffer as full as possible.

The printing device 110 may then request 212 the processed page from the network storage 106. In response, the network storage 106 may transmit the processed page to the printing device 110. The printing device 110 may then enqueue the processed page in its buffer. The time taken to communicate the request 212 may be relatively short, as the request 212 is much smaller than the size of an expected processed page. That said, the time taken to communicate the request 212 may be estimated and added to the network delay 208.

Additional or alternatively, the time taken to communicate the request 212 may be measured and added to the network delay 208. For example, the request 212 for the processed page may include a time that the request was sent by the printing device 110. Upon receiving the request 212, the network storage 106 may compute the difference between the sent time and the received time and communicate the network delay of the request 212 to the printing device 110. The printing device 110 may then add the network delay of the request 212 to the network delay 208 measured for the communication of the processed page. The network delay 208 may thus represent a measured total delay for request and response.

Further, the network delay 208 may be updated over time. Each time a processed page is transmitted 202 the network delay 208 may be updated according to computation of an average, such as a moving average or a weighted average. A moving average may be used to adjust the network delay 208 for changes in network throughput over time. A weighted average may consider the size of the processed page to quantify the network delay 208 as a time per unit size (e.g., 100 milliseconds per megabyte). Outlier measured network delays may be excluded from an average. Hence, as additional processed pages are transmitted to network storage 106, the network delay 208 may be updated to be more accurate.

Moreover, the transmission 214 of a processed page from the network storage 106 to the printing device 110 may be used to compute or update the network delay 208. The network storage 106 may inform the printing device 110 of the time of transmission of the processed page, and the printing device 110 may compute a corresponding network delay in response to receiving the processed page.

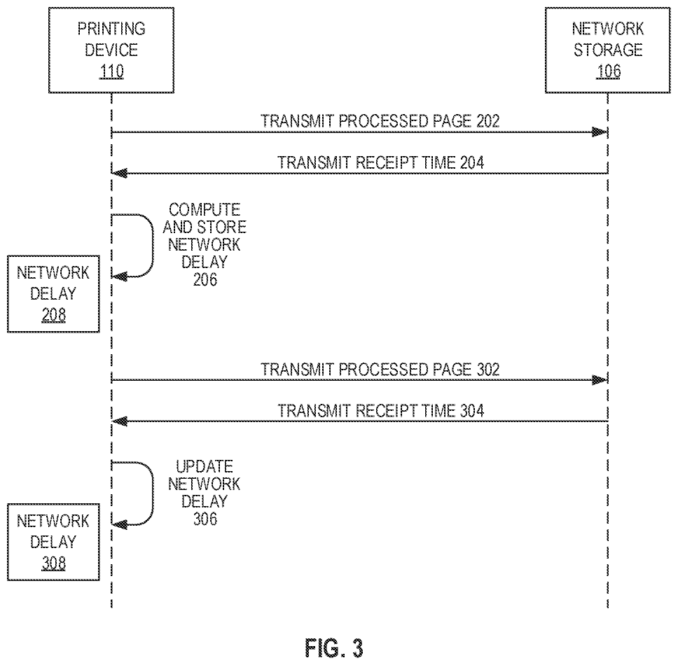

FIG. 3 shows example communications between a printing device 110 and network storage 106 to compute and update a network delay 208.

After the initial computation and storage 206 of a network delay 208 based on a measured time to transmit 202 a processed page from a printing device 110 to network storage 106, the network delay 208 may be updated. The printing device 110 may transmit 302 a subsequent processed page to the network storage 106 for temporary storage and may determine a time taken for the transmission 302, which may be based on a transmission 204 of the time of receipt received from the network storage 106. The printing device 110 may then update 306 the network delay 208 based on the time to transmit 302 the subsequent processed page. An updated network delay 308 may be computed as an average of the current network delay 208 and the newly measured network delay for the transmission 302 of the subsequent page. The network delay may be updated regularly, such as for every processed page or a sampling of processed pages. The processed pages used to compute network delay may be from the same print or copy job or different print or copy jobs. Averaging may use a moving average, so as to discount transient factors affecting network delay. Averaging may use weighting, such as weights that correlate to file size of a processed page, so that network delay approaches a time per unit of file size.

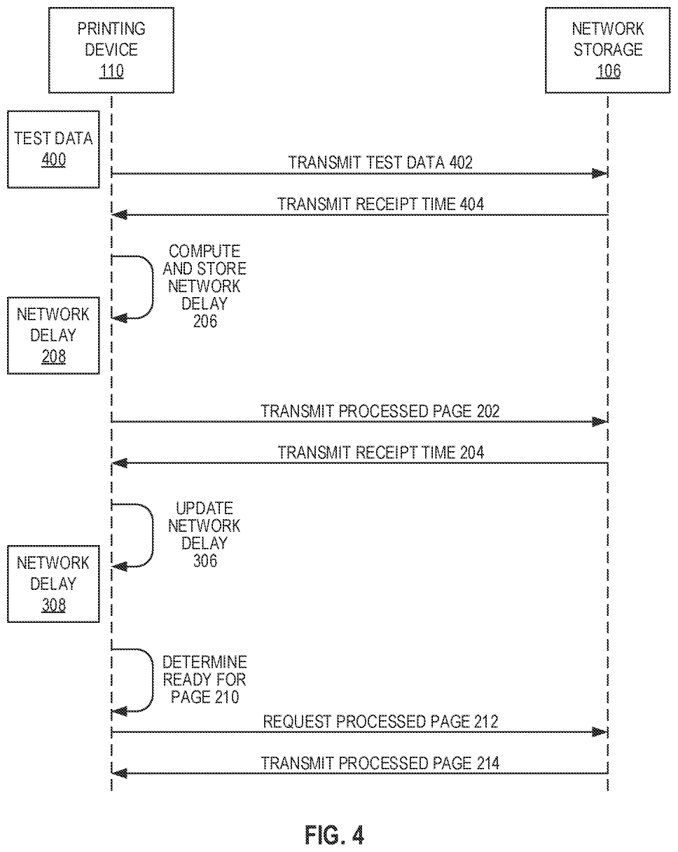

FIG. 4 shows example communications between a printing device 110 and network storage 106 to compute a network delay 208 using test data 400 and update the network delay 208 using processed page data.

The network delay 208 may be computed and stored 206 based on the communication 402 of test data 400 between the printing device 110 and the network storage 106. As with using processed page data, the time of transit of the test data 400 may be measure in either or both directions of communication between the printing device 110 and network storage 106. A response from the network storage 106 may include a transmission 404 of an indication of the transmission time, such as a time of receipt of the test data 400 at the network storage 106.

The test data may be selected to simulate an expected processed page. For example, the test data may be a rendered and compressed version of sample page of a sample document. Example test data sizes include 1, 2, and 5 megabytes, which are an order of magnitude or more larger than a ping packet.

Subsequently, the network delay 208 may be updated 306 based on a transmission 202 of a processed page between the printing device 110 and the network storage 106. An updated network delay 308 may be determined using an averaging technique, as discussed elsewhere herein. The updated network delay 308 may be used to coordinate the retrieval of the processed page via a request 212 from the printing device 110 and a responsive transmission 214 of the processed page from the network storage 106 to the printing device 110.

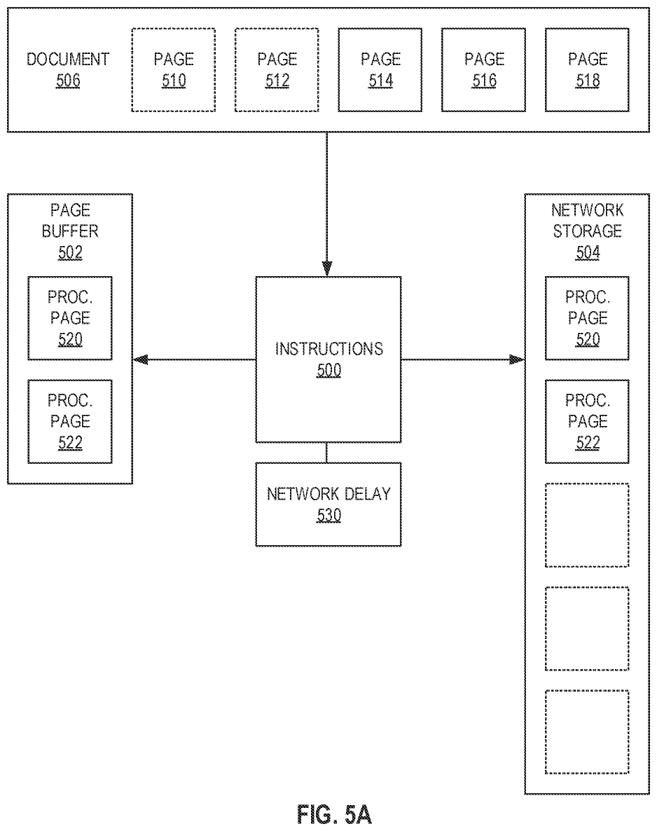

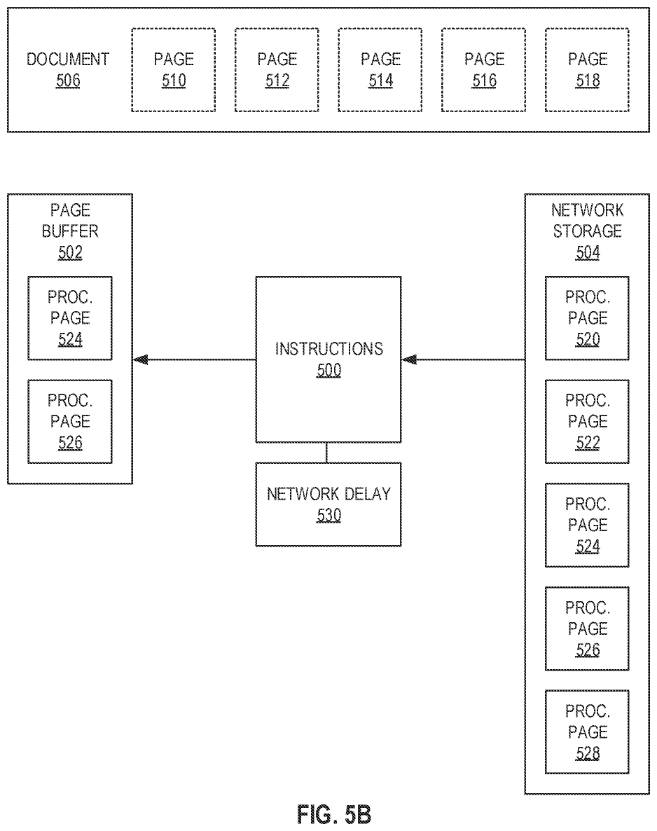

FIG. 5A shows example instructions 500, page buffer 502, and network storage 504 to process pages 510-518 of a document 506 and store processed pages 520-522 in a coordinated manner. The instructions 500 and network storage 504 may be similar to the instructions 102 and network storage 106 discussed above. The buffer 502 may be similar to the buffer discussed above. Like terminology denotes like components and the description elsewhere herein may be reference for details not repeated here.

The instructions 500 may process pages 510-518 of a document 506 to be printed by, for example, rendering and compressing page data, such as data expressed as PDL. A processed page 520 may be generated from a document page 510, a subsequent processed page 520 may be generated from a subsequent document page 510, and so on.

During the printing of a first copy of the document 506, the instructions 500 may operate maintain page buffer 502 suitably queued with processed pages 520-522, as processed pages 520-522 are dequeued for printing. The instructions 500 may further transmit processed pages 520-522 to the network storage 504 for future retrieval during printing of a subsequent copy of the document 506. For example, the instructions 300 may parse the document 506 to identify a page 510 and data thereof, process the page 510 to obtain a processed page 520, store the processed page 520 in the page buffer 502 for printing of the first copy of the document 506, and transmit the processed page 520 to the network storage 504 for storage until needed for printing a subsequent copy of the document. The instructions 300 may carry out these actions according to the rate at which the print buffer is dequeued, that is, the rate at which the processed pages 520-522 of the first copy of the document are printed.

During the communication of processed pages 520-522 to the network storage 504, the instructions 500 may measure the latency or delay associated with such communications. As discussed elsewhere herein, a network delay 530 may be measured and tracked, so that retrieval of the processed pages 520-522 may be coordinated with the usage level of the buffer 502.

In the example state illustrated, the first two pages 510-512 of a document 506 have been processed and saved in the buffer 502 and network storage 504 as processed pages 520-522. The remaining pages 514-518 of the document will be sequentially processed and saved in the buffer 502 and network storage 504 in the form of processed pages, as the buffer 502 dequeues to a print engine. To facilitate the printing of a subsequent copy of the document 506, the instructions 500 request and receive processed pages 520-522 from the network storage 504.

FIG. 5B shows a later state, during the printing of a second or subsequent copy of the document 506. All pages 510-518 have been processed and stored as processed pages 520-528 at the network storage 504.

The instructions 500 coordinate storage of the processed pages 520-528 at the buffer 502 with the retrieval of the processed pages 520-528 from the network storage 504 to maintain a queue of processed pages 520-528 in the buffer 502. This may be performed with regard to a network delay or latency 530 measured during the communication of processed pages between the buffer 502 and the network storage 504. A short network delay 530 may cause the instructions 500 to request the next processed page 520-528 from the network storage 504 when the buffer 502 has or nearly has sufficient free space. A long network delay 530 may cause the instructions 500 to request the next processed page 520-528 from the network storage 504 while the buffer 502 is still full in anticipation that sufficient free space will soon become available.

The instructions 500 request a next processed page 520-528 from the network storage when the page buffer 502 is ready to receive the next processed page 520-528. In the example illustrated, the processed page 522 has just been dequeued from the buffer 502 and the processed page 526 has just been fetched from the network storage 504 and enqueued in the buffer 502. Once the processed page 524 is dequeued or about to be dequeued, with regard to the measured network delay 530, the instructions 500 request the next processed page 528 from the network storage 504.

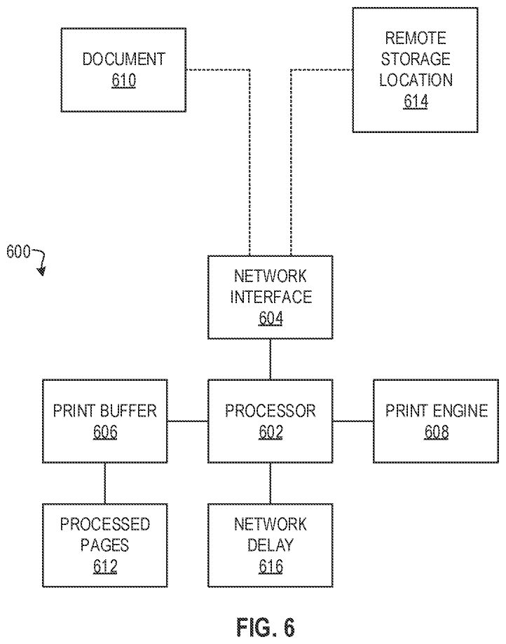

FIG. 6 shows an example printing device 600 that uses a remote network storage location to temporarily store processed pages during a multi-copy print or copy job. The printing device 600 may be inkjet printer, laser printer, multi-function device (e.g., printer, copier, and scanner), or similar.

The printing device 600 includes a processor 602, a network interface 604, a print buffer 606, and a print engine 608.

The processor 602 may include a microcontroller, a central processing unit (CPU), a field-programmable gate array (FPGA), an application-specific integrated circuit (ASIC), or a similar device capable of executing instructions. The processor 602 may be termed a print controller.

The network interface 604 is connected to the processor 602 and provides for communication with other devices, such as a host and network storage. The network interface 604 may include a physical network adaptor and a driver.

The print buffer 606 is a memory that temporarily stores a queue of processed pages. The print buffer 606 may be operated according to a first-in first-out (FIFO) scheme to deliver processed pages to the print engine 608 for printing.

The print engine 608 includes electronic and mechanical components to convert signals of processed pages received from the print buffer 606 into images to be printed to a medium, such as paper. The print engine 608 may include a media conveyance mechanism, a marking device (e.g., an inkjet printhead or a laser and toner device), and electronic components to drive such.

The processor 602 may execute a program or instructions or may be otherwise configured to receive from the network interface 604 an electronic document 610 to print and process the document 610 to obtain processed pages 612. The host may specify that multiple copies of the document 610 are to be printed. When copying a document, the processor 602 may obtain the electronic document 610 from a scanner or copier program that scans a physical copy of the document, such as may be provided to the device 600 via an automatic document feeder.

The processor 602 initiates printing of a first copy of the document 610 by providing a first processed page 612 to the print engine 608 followed by subsequent processed pages 612 in sequence.

The print buffer 606 may be insufficient in size to store all processed pages 612 of the document 610 to facilitate the printing of multiple copies without having to reprocess the document 610.

The processor 602 may determine that the print buffer 606 lacks the capacity to hold all processed pages 612. This may include reading a code associated with the document 610, where such code indicates the number of pages, and estimating page size. Such a code may be provided by the host or scanner/copies program. Alternatively or additionally, the document 610 may be pre-processed to determine the number of pages and estimate page size. Alternatively or additionally, the processor 602 may make this determination during the processing of the document 610 into processed pages 612 by keeping a running total of the size of the processed pages 612 and comparing such to the capacity of the buffer 606.

Accordingly, and in response to determining that multiple copies of the document 610 are to be printed, the processor 602 transmits a processed temporarily store the processed page 612 for subsequent retrieval when printing a subsequent copy of the document.

The processor 602 characterizes a network delay 616 for access to the remote storage location 614 by timing communications between the network interface 604 and the remote storage location 614. A timed communication may include a processed page 612 transmitted to or from the remote storage location 614, test data transmitted to or from the remote storage location 614, and a request for a processed page 612 transmitted to the remote storage location 614. Measured times may be combined and averaged, and further may be updated as subsequent communications are timed, so that the network delay 616 represents a current expected time for the printing device 600 to obtain a processed page 612 from the remote storage location 614.

During the printing of a second or subsequent copy of the document 610, the processor 602 coordinates requests to obtain processed pages 612 from the remote storage location 614 based on the network delay 616 and the state of the print buffer 606. As the buffer 606 dequeues processed pages 612 to the print engine 608, the processor 602 requests subsequent processed pages 612 from the remote storage location 614. If the buffer 606 is emptying rapidly, the processor 602 may request the next processed page 612 relatively quickly. The processor 602 may preemptively request the next processed page 612 even if the buffer 606 does not currently have space for the processed page 612. A preemptive request may be particularly useful for a long network delay 616. Conversely, if the buffer 606 is emptying slowly, the processor 602 may delay the request the next processed page 612 and such delay may be longer than the network delay 616. The processor 602 may coordinate requests to obtain processed pages 612 from the remote storage location 614, with regard to the network delay 616, to maintain the print buffer 606 as full as possible.

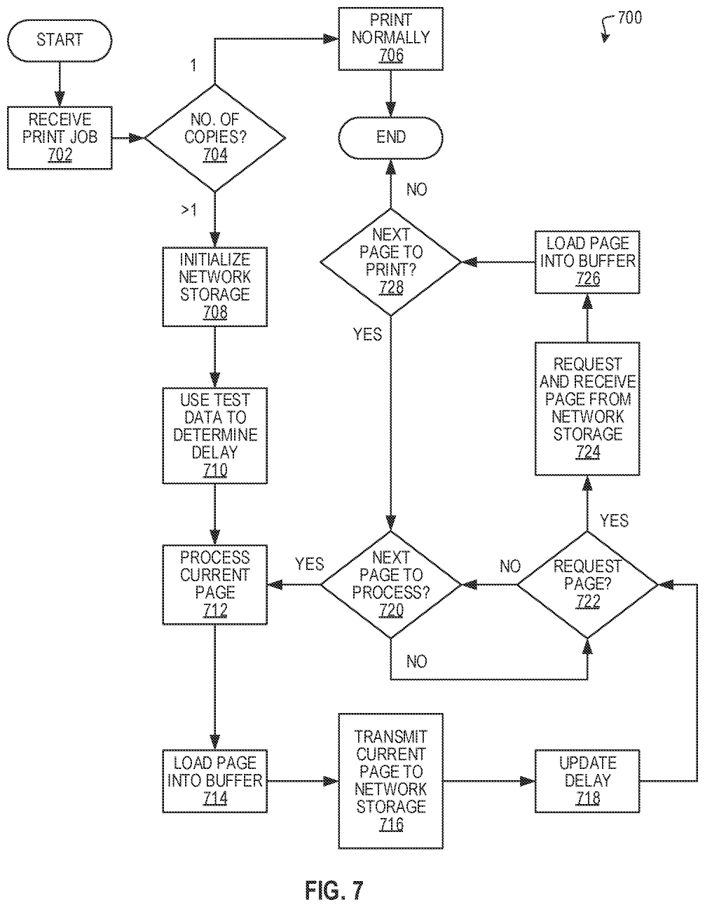

FIG. 7 shows an example method 700 of storing and retrieving processed pages via network storage during the printing of multiple copies of a document. The method 700 may be performed by a processor and/or instructions, as discussed above.

At block 702, a print or copy job is received at a printing device. Job data, such as a number of copies to print, may be read.

At block 704, if the number of copies is not more than one, then the document is processed and printed normally, at block 706.

At block 708, a network storage location may be initialized when multiple copies are to be printed.

At block 710, test data may be communicated to the network storage location to determine the responsiveness of the network storage location. The time take to transmit, receive, or both transmit and receive the test data may be measured. The test data may be selected to represent a typical or average page size. A network delay may thus be initially characterized. This may be done while parsing of the document begins and the first page of the document is processed (e.g., rendered and compressed), at block 712.

At block 712, the current page is processed to obtain a corresponding processed page. A two-stage parser, one stage for PDL and another for PJL, may be used.

The number of pages of the document may be determined at block 702, if this information is provided with the print or job data, or as part of block 712, if this information is explicitly specified in or with the document, such as by a code embedded in PDL or other metadata of the document. That said, the number of pages may not be determined at this time, and the number of pages may be determined as the method 700 proceeds.

At block 714, after the current page is processed, the processed page is sequenced for printing. This may include loading the processed page into the print buffer at an appropriate position in a queue. A print engine may deque processed pages from the buffer to carry out printing asynchronously to the loading of processed pages into the buffer.

At block 716, after the current page is processed, the processed page is transmitted to the network storage location.

At block 718, the time to send the processed page is determined and compared to the network delay determined from the test data and any other pages transmitted to the network storage location by this point. The network delay may be updated by, for example, averaging in the send time for the current processed page. Alternatively, if the send time for the current processed page is slower than the network delay, the network delay may be set to the send time for the current processed page. In addition, the size of the processed page is determined and recorded to track memory (e.g., page buffer) requirements at the printing device.

Via block 720, the next page is processed, if any. The subprocess defined by blocks 712-718 may be performed until no more pages remain to be processed. By the time the end of the document is reached, a number of pages may already have been printed, and all processed pages have been stored at the network storage.

During and after the processing of the pages, block 722 may determine whether to request a processed page from network storage. Block 722 coordinates obtaining processed pages from network storage and usage of the memory at the printer with any page processing that remains to be performed. As shown, if all pages have been processed and saved to network storage, the method 700 continually checks the condition defined by block 222 to determine whether or not to request the next processed page.

The condition enforced by block 722 includes determining if the buffer has sufficient space for the next page to be printed for copies after the first copy. The measured network delay may also be referenced. That is, the condition may be defined as: will the buffer have sufficient space for the next page after the network delay elapses? If not, then the block 722 is evaluated again until the condition is met. When the condition is met, then the next processed page is requested from network storage at block 724.

The next page, as considered at block 722, is a page of a copy subsequent to the first copy of the document. Hence, while page processing is underway during the printing of the first copy, the condition enforced by block 722 may also consider whether or not the end of the document has been determined. If the end of the document has not yet been determined, then the condition of block 722 is not met because there may be any number of pages yet to process that require full use of the buffer. That is, the buffer may be required to queue a yet unknown number of pages of the first copy for printing, as such pages are processed. Once the end of the document is determined, the demand on the buffer may be quantifiable and the condition at block 722 may be met. The total space required for the pages yet to be processed may be considered along with the size of the processed page to obtain from network storage. The total space required for the pages yet to be processed may be estimated based on the sizes of pages already proceed. If the buffer has sufficient capacity for the pages yet to be processed and for the page to be requested from network storage, then the condition of block 722 may be considered to be met. In addition, an early indication of the number of pages of the document, such as by a code provided with the document, may allow for an earlier determination that the buffer has sufficient capacity to being requesting processed pages from network storage. This may increase usage of the buffer and document printing throughput.

In addition, if pages are still undergoing processing, via blocks 720 and 712-718, then some amount of memory may be used to process pages and thus may be unusable as buffer. Conversely, once processing is complete, such working memory may be freed to increase the amount of buffer space available to store processed pages received from network storage.

Once all pages have been processed and stored at network storage, the condition at block 722 returns to be whether or not the buffer will have sufficient space for the next processed page to be obtained from network storage considering the network delay.

At block 724, the next page is requested and received from network storage, and loaded into the buffer, at block 726.

Then, block 728 determines whether or not there are still pages to print and either ends the method 700 or returns to block 720 to determine whether pages remain to be processed.

As can be seen, factors that may govern the speed of printing while pages are being processed (blocks 712-718) include the speed at which the printer mechanism operates and the speed at which pages are processed. The buffer may be kept as full as possible with processed pages for the first copy of the document. The condition at block 722 is not satisfiable until the end of the document is determined. Once the end of the document has been determined, a transitory state may exist, in which pages may still be undergoing processing but the condition at block 722 may be satisfiable if the buffer has sufficient space. Blocks 712-718 and 724-728 may be performed. For example, the buffer may still queue processed pages of the first copy of the document and additional pages may still be undergoing processing, so that the buffer is to expect additional processed pages for the first copy. If the buffer has free capacity beyond that, then the condition of block 722 may allow for initial pages of the second copy to be obtained from network storage and queued in the buffer. Advanced indication of the number of pages contained in the document, such as with a code provided with the document, may facilitate earlier fetching of processed pages for the second copy. Once processing is completed, the transitory state ends and block 722 meters the obtaining of processed pages from network storage based on buffer level with consideration of the network delay, via blocks 724-728. The governing factor at this time may be the speed at which the printer mechanism operates provided that processed pages are requested with regard to network delay to keep the buffer loaded with processed pages.

In view of the above, it should be apparent that network storage may be used to facilitate the efficient printing of multiple copies of a document. A network delay may be characterized to provide for efficient request and receipt of processed pages for printing of a second or subsequent copy of the document. The demand on resources of the host and printer may be reduced.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by a processor, cause the processor to:
receive a job to print multiple copies of a document;
process a page of the document to obtain a processed page;
initiate printing of the processed page at a printer;
transmit via a network the processed page to network storage; and
when ready to print a subsequent copy of the page of the document, retrieve via the network the processed page from the network storage.

2. The non-transitory machine-readable medium of claim 1, wherein the instructions are further to:
determine a network delay as a time of communication of the processed page between the printer and the network storage; and
coordinate retrieval of processed pages from the network storage based on the network delay.

3. The non-transitory machine-readable medium of claim 2, wherein the instructions are further to:
update the network delay based on a subsequent time of communication of a subsequent communication of a subsequent processed page between the printer and the network storage.

4. The non-transitory machine-readable medium of claim 3, wherein the subsequent processed page is from the job.

5. The non-transitory machine-readable medium of claim 3, wherein the subsequent processed page is from a subsequent job that is different from the job.

6. The non-transitory machine-readable medium of claim 2, wherein the instructions are further to:
based on the network delay, coordinate storage of the processed pages at a buffer of the printer with the retrieval of the processed pages from the network storage to maintain a queue of the processed pages in the buffer of the printer.

7. The non-transitory machine-readable medium of claim 1, wherein the instructions are further to:
determine a network delay by communicating test data with the network storage; and
coordinate retrieval of the processed page at the network storage based on the network delay.

8. The non-transitory machine-readable medium of claim 1, wherein the instructions are further to:
determine a number of pages of the document; and
reserve an amount of the network storage based on the number of pages.

9. A printing device comprising:
a network interface;
a processor connected to the network interface, the processor to:
receive from the network interface a document to print;
process the document to obtain processed pages to print a first copy of the document;
initiate printing of a first copy of a processed page; and
in response to determining that multiple copies of the document are to be printed, transmit the processed page via the network interface to a remote storage location to temporarily store the processed page for subsequent retrieval to print a subsequent copy of the document.

10. The printing device of claim 9, wherein the processor is further to:
request the processed page from the remote storage location;
receive the processed page via the network interface; and
initiate printing of a subsequent copy of a processed page.

11. The printing device of claim 9, further comprising a page buffer connected to the processor, wherein the processor is further to coordinate storage of the processed pages at the page buffer with storage of the processed pages at the remote storage location to maintain a queue of the processed pages at the page buffer.

12. The printing device of claim 9, wherein the processor is further to:
measure a delay to communicate the processed page with the remote storage location; and
coordinate a request to obtain a subsequent processed page from the remote storage location based on the delay.

13. The printing device of claim 9, wherein the processor is further to:
measure a delay to communicate test data with the remote storage location; and
coordinate a request to obtain the processed page from the remote storage location based on the delay.

14. The printing device of claim 13, wherein the test data is selected to simulate an expected processed page.

15. The printing device of claim 9, wherein the processor is to render and compress data of the document to obtain the processed pages, and wherein the processed page is transmitted to the remote storage location in rendered and compressed form.

16. A device comprising:
a buffer to store rendered and compressed pages of a print job for a printer; and
a processor connected to the buffer, wherein the processor is to:
render and compress a document received from a host to generate the rendered and compressed pages of the print job; and
temporarily store a rendered and compressed page at a network storage device that is remote from the buffer.

17. The device of claim 16, wherein the processor is to retrieve the rendered and compressed page from the network storage device and load the rendered and compressed page into the buffer to initiate printing of the rendered and compressed page.

18. The device of claim 16, wherein the processor is to coordinate a retrieval of the rendered and compressed page from the network storage device processor based on a latency of the network storage device and a quantity of rendered and compressed pages in the buffer to maintain continuous operation of the printer.

19. The device of claim 18, wherein the processor is to determine the latency of the network storage device by timing communication of the rendered and compressed pages.

20. The device of claim 19, wherein the processor is to regularly update the latency during the print job or during a subsequent print job.
